(19) United States
(12) Patent Application Publication
(10) Pub. No.: US 2010/0156838 A1
(43) Pub. Date: Jun. 24, 2010

(54) CAPACITIVE INPUT DISPLAY DEVICE

(76) Inventor: Sang-Youl HAN, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/338,999

(22) Filed: Dec. 18, 2008

(51) Int. Cl. G06F 3/045

(52) U.S. Cl. 345/174

(57) ABSTRACT

Disclosed herein is a capacitive input display device, including: a display module 10 for displaying predetermined input contents; an input module 20 including a first pole plate 21 disposed on an outer periphery of the display module 10, an elastic layer 22 which is placed on the first pole plate 21 and whose thickness is changed by application of pressure and is then elastically restored, and a second pole plate 23 placed on the elastic layer 22 so that the second pole plate 23 is spaced apart from the first pole plate 21 by a distance corresponding to the thickness of the elastic layer 22, in which at least one of the first pole plate 21 and the second pole plate 23 is composed of a plurality of segments; and a window 30 placed on the input module 20, wherein the distance between the first pole plate 21 and the second pole plate 23 is changed at overlapping positions thereof by an external pressure applied to the window 30 so that the difference in patterns of capacitance change caused by the change of the distance generate different input signals.

### BACKGROUND OF THE INVENTION

1. Field of the Invention

The present invention relates to a capacitive input display device, and, more particularly, to a capacitive input display device which can be suitably used as an input display device in various mobile terminals such as mobile phones and the like.

2. Description of the Related Art

Various mobile terminals, such as mobile phones, MP3 players, PDAs (Personal Digital Assistants), portable game machines, DMB (Digital Multimedia Broadcast) receivers and the like, are provided with an input device for operation and data input.

Since such mobile terminals are increasingly loaded with various menus and their several functions are gradually integrated into one singular function, the operation of their input devices has become more various and thus the number of operations of the input devices has also increased.

A keypad equipped with dome switches has been used as an input device of a mobile terminal, but a capacitive input device has been introduced instead of the keypad in order to slim the input device. Such a capacitive input device is being variously applied to the miniaturization of mobile phones.

As well known to those skilled in the art, a capacitive input device applied to a mobile terminal is configured such that a plurality of pole plates (electrode plates, for example, copper plates) corresponding to input keys is disposed on a substrate at regular intervals and voltages are applied to these pole plates. In this capacitive input device, when fingers come into contact with the pole plates (that is, sensing points for detecting the contact of fingers), parasitic capacitances due to the electric permittivities between the fingers and the pole plates are detected and thus it is determined whether any pole plate has been selected, and then input signals derived from the selected pole plate are transmitted to a CPU (Central Processing Unit) of a mobile terminal, thereby operating the capacitive input device.

As mobile terminals are miniaturized, the intervals between buttons of a keypad have narrowed. Accordingly, when a user pushes a button, other buttons adjacent to the desired button may be pushed, thereby increasing possibility of the abnormal operation of the mobile terminals. Under these circumstances, a capacitive input device is used as an input device of the mobile terminal, and thus the problem of the abnormal operation of the mobile terminal is partially solved.

Korean Patent Registration No. 661,000 (registration date: Dec. 18, 2006), filed by the present applicant, discloses ‘an input device for a portable electronic device’. The input device creates various input signals by using the change of capacitance attributable to the change of contact pressure, instead of by detecting the parasitic capacitances generated by bringing fingers into contact with pole plates. Therefore, the input device can be precisely operated without concomitant abnormal operation.

Meanwhile, many input display devices in which an input device and a display device are integrated are widely disclosed. For example, Korean Patent Registration No. 10-0493921 (registration date: Jun. 10, 2005) discloses ‘a touch panel integrated with a flat panel display’, Korean Patent Registration No. 10-0487355 discloses ‘an electro-optical display device integrated with a touch panel’, and Korean Unexamined Patent Publication No. 2001-0091312 discloses ‘a display assembly integrated with a touch panel’.

These conventional input display devices each have a basic structure in which an input device (a touch pad, a touch screen or the like) is attached on the entire upper surface of a display device. In this case, even when the input device is made of a transparent material, since the display device is entirely covered with the input device, the light transmission rate of the display device is decreased by the input device placed thereon, and thus the definition of an image displayed on the display device is deteriorated.

### SUMMARY OF THE INVENTION

Accordingly, the present invention has been made keeping in mind the above problems occurring in the prior art, and an object of the present invention is to provide an input display device which can be suitably used in mobile terminals, in which the definition of contents displayed on a display device is not influenced by an input device even though the input device (input module) is placed on the display device (display module), and thus the contents are definitely displayed on the display device as in the case when the input device is not placed on the display device, and in which its manufacturing process is simple, and thus the production costs thereof can be reduced.

In order to accomplish the above object, the present invention provides a capacitive input display device which can be properly applied to in a mobile terminal.

The capacitive input display device includes a display module, an input module, and a window.

The display module displays predetermined input contents.

The input module includes a first pole plate disposed on an outer periphery of the display module, an elastic layer which is placed on the first pole plate and whose thickness is changed by application of pressure and is then elastically restored, and a second pole plate placed on the elastic layer so that the second pole plate is spaced apart from the first pole plate by a distance corresponding to the thickness of the elastic layer, in which at least one of the first pole plate and the second pole plate is composed of a plurality of segments.

The window is placed on the input module.

In capacitive input display device, the distance between the first pole plate 21 and the second pole plate 23 is changed at overlapping positions thereof by an external pressure applied to the window 30 so that the difference in patterns of capacitance change caused by the change of the distance generate different input signals.

The first pole plate is composed of the plurality of segments, and the second pole plate is a single pole plate or is composed of two or more pole plate segments.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic block diagram showing a mobile terminal provided with an input display device according to an embodiment of the present invention;

FIG. 2 is a schematic view of an input display device according to an embodiment of the present invention;

FIG. 3 is an exploded view of an input display device according to an embodiment of the present invention;

FIG. 4 is an assembled sectional view of an input display device according to an embodiment of the present invention; and

FIG. 5 is a view showing the operation of an input display device according to an embodiment of the present invention.

### DESCRIPTION OF THE PREFERRED EMBODIMENTS

Hereinafter, preferred embodiments of the present invention will be described in detail with reference to the attached drawings.

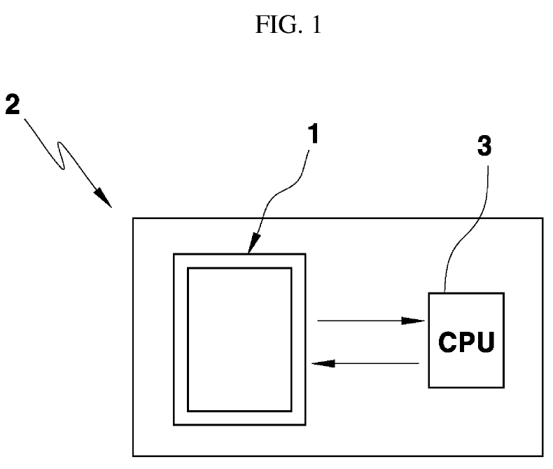

As shown in FIG. 1, a capacitive input display device 1 according to the present invention is an input display device used to input various data or information to various mobile terminals 2, such as mobile phones, MP3 players, PDAs (Personal Digital Assistants), portable game machines, DMB (Digital Multimedia Broadcast) receivers and the like, and to display contents. For example, the input display device 1 functions to input and display predetermined contents using a program loaded in a CPU 3 of a mobile terminal 2.

The detailed description of the configuration of the circuit connection of the input display device 1 and the mobile terminal 2 will be omitted because it is not directly related to the features of the present invention and it can be easily understood by making reference to conventional technologies.

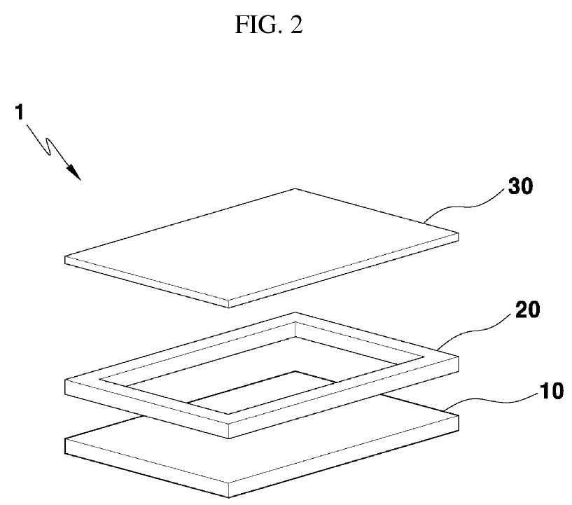

As shown in FIGS. 2 to 4, the input display device 1 of the present invention, similar to a conventional input display device, has a structure in which an input module 20 and a window 30 is sequentially placed on a display module 10.

The display module 10 applied to the present invention is a general display module which can be suitably applied to various mobile terminals such as mobile phones and the like. For example, LCDs, which are widely used as display means of mobile terminals, can be applied to the display module 10 of the present invention.

The display module 10 serves to display various contents related to the use of mobile terminals, including the input contents input by the input module 20.

The input contents input by the input module 20 may be displayed on the display module 10 using technologies widely applied to a well known touch screen, which is a typical input display device, in accordance with the use and function of the input display device 1 of the present invention.

The detailed description of the configuration of the display module 10 itself and the interaction between the display module 10 and the input module 20 will be omitted because they are not directly related to the features of the present invention and they can be easily understood with reference to conventional technologies.

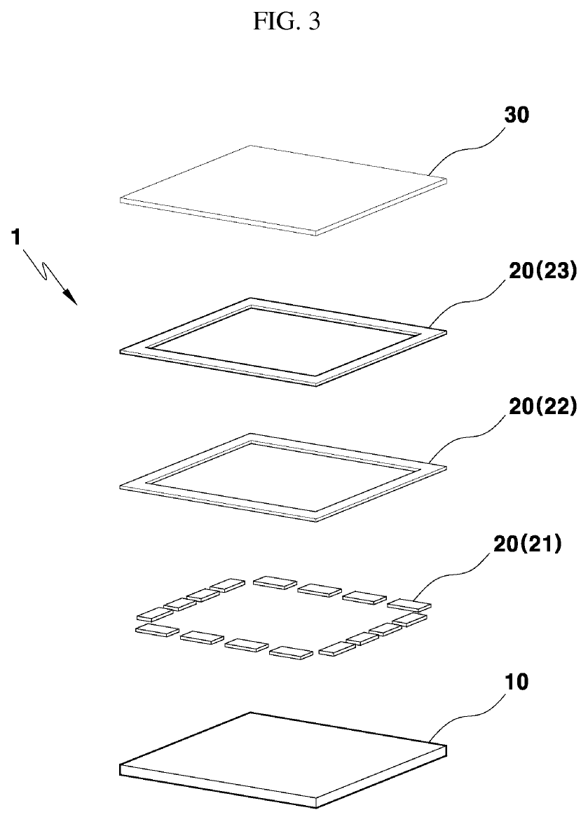

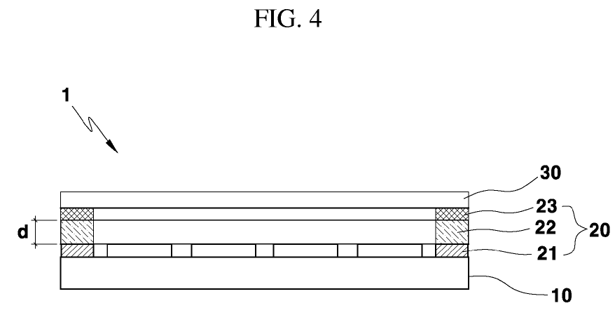

As shown in FIGS. 3 and 4, the input module 20 applied to the input display device 1 of the present invention includes a first pole plate 21, an elastic layer 22 and a second pole plate 23. At least one of the first pole plate 21 and the second pole plate 23 is composed of a plurality of segments.

The first pole plate 21 and the second pole plate 23 are connected to a controller through a matrix circuit (not shown), and the controller generates input signals using a loaded program and then transmits the input signals to the CPU 3 of the mobile terminal 2 provided with the input display device 1 of the present invention.

The first pole plate 21 is an electrode plate used in a general capacitive input device, and is made of a conductive material such as a copper plate.

According to an embodiment of the present invention, at least one of the first pole plate 21 and the second pole plate 23 is composed of a plurality of segments. That is, in an embodiment of the present invention, the first pole plate 21 is composed of a plurality of segments and the second pole plate 23 is a single pole plate or is composed of a plurality of segments, but, conversely, the second pole plate 23 may be composed of a plurality of segments and the first pole plate 21 may be a single pole plate or be composed of a plurality of segments.

According to another embodiment of the present invention, the first pole plate 21 is placed on the outer periphery of the display module 10, not on the entire upper surface thereof.

In the input display device of the present invention, the input module 20 including the first pole plate 21, elastic layer 22 and second pole plate 23 is placed only on the outer periphery of the display module 10, not on the entire upper surface thereof, thus preventing the deterioration of the definition of the contents displayed on the display module, occurring when the input module 20 is placed on the entire upper surface of the display module 10.

The operation for inputting predetermined contents on the display module 10 when the input module 20 is placed on only the outer periphery of the display module 10 will be described later.

FIG. 3 shows an example in which a first pole plate 21 composed of total 16 rectangular segments is disposed on the outer periphery of a rectangular display module 10. However, the shape, size and segment number of the first pole plate 21, the distance between the adjacent segments of the first pole plate 21, and the placement of the segments of the first pole plate 21 may be properly selected in accordance with the kind of a mobile terminal provided with the input display device 1 of the present invention, the size of the space of the mobile terminal necessary for providing the input display device 1 and the kind and sensitivity of the input operation of the input display device 1 of the present invention as long as the contents displayed on the display module 10 are not blocked.

The elastic layer 22 is placed on the first pole plate 21 at a predetermined thickness (d). Here, the elastic layer 22 is also placed on the outer periphery of the first pole plate 21, not the entire upper surface of the display module 10.

The elastic layer 22 acts as a dielectric placed between the two pole plates 21 and 23. In the elastic layer 22, the thickness (d) of the electric layer 22 is elastically changed by an applied external pressure, so that the distance (d) between the first pole plate 21 and the second pole plate 23 is also changed, with the result that the capacitances of sensing points corresponding to overlapping positions of the first pole plate 21 and the second pole plate 23 are changed by the applied external pressure.

The elastic layer 22 may be made of a well known thermoplastic elastomer (TPE) selected from among polyolefin elastomers, PVC elastomers, polystyrene elastomers, polyester elastomers, polyurethane elastomers, polyamide elastomers, and the like.

Like the first pole plate 21, the second pole plate 23 is made of a conductive material such as copper plate, and, as described above, is placed at a position spaced apart from the first pole plate 21 by a predetermined distance (d), and the elastic layer 22 is located between the first pole plate 21 and second pole plate 23. Like the first pole plate 21 and the elastic layer 22, the second pole plate 23 is also placed on the outer periphery of the elastic layer 22, not the entire upper surface of the display module 10.

According to the embodiment of the present invention, the first pole plate 21 is composed of a plurality of segments, but, as shown in FIG. 3, the second pole plate 23 may be a single pole plate covering the entire surface of the first pole plate 21, may be composed of two or more pole plate segments, or may be formed at positions corresponding to the strips of the first pole plate 21.

These first and second pole plates 21 and 23 are connected to matrix circuits formed corresponding to the number of the pole plates.

As such, since the first pole plate 21 composed of the plurality of segments and the second pole plate 23 are provided therebetween with the elastic layer 22, the second pole plate 23 is placed at a position spaced apart from the first pole plate 21 by the distance (d) corresponding to the thickness of the elastic layer 22. The overlapping positions of the first pole plate 21 and the second pole plate 23 are positions at which both the first pole plate 21 and the second pole plate 23 are located. These overlapping positions form sensing points for causing capacitance change by external pressure.

The window 30 is a transparent plate-shaped member covering the entire upper surface of the input module 20, and serves to protect the display module 10 and input module 20 and to directly receive an external pressure and then transfer the external pressure to the input module 20.

In the description of the input display device 1 of the present invention, it is described that the window 30 is equal to the display module 10 and input module 20, but it can be understood that the window 30 is a constituent of the input module 20, the window 30 being placed on the second pole plate 23 of the input module 20.

As described above, according to the input display device 1 of the present invention, when an external force is applied to predetermined positions of the windows 30 and thus the predetermined positions of the input module 20 is pressurized, at sensing points existing under the pressurized positions of the input module 20, the second pole plate 23 and elastic layer 22 are pressurized, so that the elastic layer 22 is constricted and thus the distance (d) between the first pole plate 21 and the second pole plate 23 is changed (decreased). Due to the change in the distance (d), at the corresponding sensing points, the change of capacitance, represented by the Equation C=μA/d (wherein C is capacitance, μis dielectric permissivity, A is area, and d is distance between first pole plate 21 and second pole plate 23), occurs. In this case, the variation of capacitance is changed depending on the intensity of the applied pressure. Thereafter, when the external force is removed, the elastic layer 22 and the second pole plate 23 return to the original position because of the elasticity of the elastic layer 22.

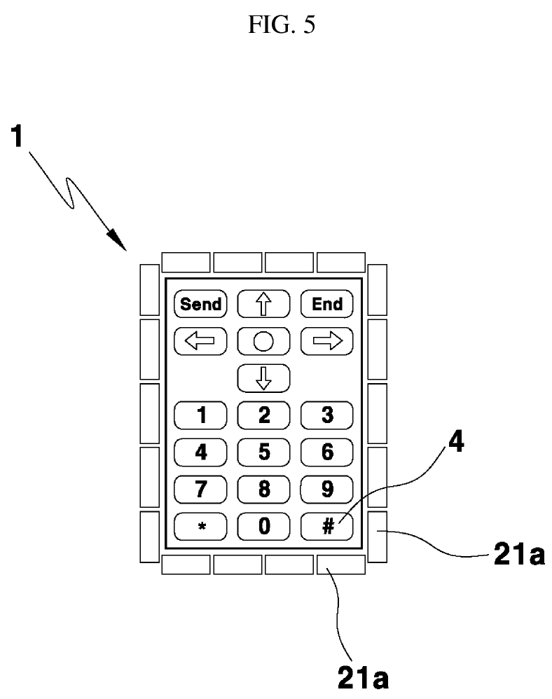

Hereinafter, an operation for inputting contents to the input display device 1 of the present invention will be described with reference to FIG. 5.

For convenience, it is supposed that input contents 4, such as a number of 0˜9, *, #, ↑ ↓ ← →, Send, End and the like, are displayed on the display module 10 of the input display device 1 of the present invention, and one of the displayed input contents 4 is selected and input.

Specifically, when ‘#’ is pushed, the window 30 on which ‘#’ is displayed is pressurized, and thus the input module 20 placed beneath the window 30 is pressurized. In this case, among the plurality of first pole plates 21, the first pole plates 21a closest to ‘#’ are most greatly pressurized, and thus the distance (d) in sensing points including the first plates 21a becomes shortest, thereby most greatly increasing the change in capacitance. Further, as the first pole plates 21 become more distant from the first pole plate 21a, they are more slightly pressurized, and thus the distance (d) is slightly changed, thereby decreasing the change of capacitance. These capacitance change patterns vary depending on the pressurized positions of the window 30.

Therefore, the capacitance change patterns of all the sensing points located on the window 30 with respect to the external pressure are previously measured and stylized, and the stylized capacitance change patterns and the predetermined input contents corresponding thereto are stored in the input display device 1 of the present invention or the mobile terminal 2 provided with the input display device 1. Then, capacitance change patterns, which are actually measured when the predetermined points of the window 30 is pressurized in order to input predetermined contents to the input display device of the present invention, is compared with the stylized capacitance change patterns, and thus it can be determined what contents have been input by real pressurization.

Accordingly, in the input display device 1 of the present invention, even when the input module 20 is placed only on the outer periphery of the display module 10, not on the entire upper surface of the display module 10, it is determined that any point of the entire surface of the window 30 is pressurized, and thus the content 4 corresponding to the point can be input.

In a conventional capacitive input device, parasitic capacitances can be detected by bringing a finger into contact therewith, but, the input module 20 applied to the capacitive input display device of the present invention can be sufficiently used as long as it is pressurized to such a degree that the distance (d) is changed.

Meanwhile, in the case of applying the input display device 1 of the present invention to a mobile terminal, only a set of contents can be input through the input module 20, and only a set of contents corresponding thereto can be displayed on the display module 10, but, if necessary, two or more sets of contents can be selectively input through the input module 20 or can be selectively displayed on the display module 10.

For example, when a mobile phone 2 provided with the input display device 1 of the present invention is used to speak to another person, as shown in FIG. 5, the input contents 4, such as a number of 0˜9, *, #, ↑ ↓ ← →, Send, End and the like, can be input and displayed. Further, when the mobile phone 2 is used to play a game, other input contents necessary for the game can be input and displayed.

Like this, two or more sets of input contents can be input and displayed using the input display device 1 of the present invention, and thus the display module 10 and input module 20 can be properly connected to circuits related to a mobile terminal 2, and necessary programs can be loaded on the mobile terminal 2.

As described above, according to the input display device of the present invention, since an input module is placed only on the outer periphery of a display module, not on the entire upper surface of the display module, most of the contents displayed on the display module are not blocked by the input module, thus preventing the definition of the contents displayed on the display module from being deteriorated by the input module. Further, since the input display device of the present invention includes an input module having a very simple structure, its production costs can be reduced, and it can be effectively used to design small-sized mobile terminals.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A capacitive input display device, comprising:
a display module 10 for displaying predetermined input contents;
an input module 20 including a first pole plate 21 disposed on an outer periphery of the display module 10, an elastic layer 22 which is placed on the first pole plate 21 and whose thickness is changed by application of pressure and is then elastically restored, and a second pole plate 23 placed on the elastic layer 22 so that the second pole plate 23 is spaced apart from the first pole plate 21 by a distance corresponding to the thickness of the elastic layer 22, in which at least one of the first pole plate 21 and the second pole plate 23 is composed of a plurality of segments; and
a window 30 placed on the input module 20,
wherein the distance between the first pole plate 21 and the second pole plate 23 is changed at overlapping positions thereof by an external pressure applied to the window 30 so that the difference in patterns of capacitance change caused by the change of the distance generate different input signals.

2. The capacitive input display device according to claim 1, wherein the first pole plate 21 is composed of the plurality of segments, and the second pole plate 23 is a single pole plate or is composed of two or more pole plate segments.
